(19) United States
(12) Patent Application Publication
(10) Pub. No.: US 2025/0180932 A1
(43) Pub. Date: Jun. 5, 2025

(54) OPTICAL WAVEGUIDE ELEMENT, AND OPTICAL MODULATION DEVICE AND OPTICAL TRANSMISSION DEVICE USING SAME

(71) Applicant: SUMITOMO OSAKA CEMENT CO., LTD., Tokyo (JP)

(72) Inventors: Junji ARAI, Tokyo (JP); Yumi MURATA, Tokyo (JP); Yuki KUGIMOTO, Tokyo (JP)

(73) Assignee: SUMITOMO OSAKA CEMENT CO., LTD., Tokyo (JP)

(21) Appl. No.: 18/846,124

(22) PCT Filed: Mar. 31, 2022
(86) PCT No.: PCT/JP2022/016659

§ 371 Date: Sep. 11, 2024

(51) Int. Cl. G02F 1/01; G02B 6/30

(52) U.S. Cl. CPC G02F 1/0113; G02B 6/30; G02F 1/0121

(57) ABSTRACT

An object of the present invention is to provide an optical waveguide device capable of appropriately setting a joint relationship between an optical waveguide substrate and a reinforcing member. An optical waveguide device includes an optical waveguide substrate 1 (11) provided with an optical waveguide 10; and a reinforcing member 2 disposed on an upper side of the optical waveguide near an end portion of the optical waveguide, the optical waveguide substrate and the reinforcing member being joined through an adhesive layer AD, in which a plurality of structures are disposed between the optical waveguide substrate and the reinforcing member to interpose the optical waveguide between the plurality of structures, for a first structure ST1, the adhesive layer is disposed between an upper surface of the structure and the reinforcing member, and the first structure ST1 has a ratio of an area of the upper surface to an area of a lower surface of the reinforcing member being set to be equal to or more than a predetermined ratio, and a second structure ST2 is configured to set a thickness of the adhesive layer disposed between the first structure and the reinforcing member within a predetermined range.

### TECHNICAL FIELD

The present invention relates to an optical waveguide device, and an optical modulation device and an optical transmission apparatus using the same and, particularly to an optical waveguide device including an optical waveguide substrate provided with an optical waveguide, and a reinforcing member disposed on an upper side of the optical waveguide near an end portion of the optical waveguide, the optical waveguide substrate and the reinforcing member being joined through an adhesive layer.

### BACKGROUND ART

In the field of optical measurement technology or in the field of optical communication technology, optical waveguide devices such as an optical modulator using a substrate on which an optical waveguide is formed have been widely used. For example, an optical waveguide is formed by thermally diffusing a material with a high refractive index, such as Ti or the like, on a substrate or the like having an electro-optic effect, such as lithium niobate (LN), or by forming a rib structure (protruding portion). In the optical waveguide substrate on which the optical waveguide is formed, input light is introduced from the outside or output light is output to the outside. In order to introduce the input light from the outside into the optical waveguide on the substrate, an optical block such as an optical fiber, a lens, or the like is connected to an end surface of the substrate on which an input portion of the optical waveguide is formed. In addition, in order to appropriately output the output light, an optical block such as an optical fiber, a lens, polarization combining means, reflecting means, or the like is connected to an end surface of the substrate on which an output portion of the optical waveguide is formed.

In connecting the optical block to the optical waveguide substrate, a reinforcing member is fixed on the substrate along the end surface of the optical waveguide substrate using an adhesive (adhesive layer) in order to more firmly fix the optical block. Accordingly, the optical block is joined to two end surfaces of the optical waveguide substrate and the reinforcing member.

On the other hand, with the increase in communication traffic in recent years, for optical modulators, there is a desire for speed enhancement and size reduction because of a restricted installation space. Therefore, it is required to form the optical waveguide of the optical waveguide device to be incorporated into the optical modulator in a rib structure and to reduce the mode field diameter (MFD) of the light wave to about 1 μm. Since the confinement of light is increased by the reduction in diameter, a bending radius of the waveguide can be reduced, allowing sizes of the optical waveguide device and the optical modulator to be reduced.

However, an optical component, such as an optical fiber or the like, that is joined to an end surface of the optical waveguide of the optical waveguide device has an MFD of about 10 μm, which is significantly different from the MFD of the optical waveguide (for example, 3 μm or less). Therefore, to reduce optical coupling loss, a spot size converter is placed at an end portion of the optical waveguide device, increasing the MFD. Even in a case where the spot size converter is used, the reinforcing member (upper substrate) is disposed along the end surface of the optical waveguide substrate to increase the joint strength with the optical component, such as an optical fiber or the like, that is joined to the end portion of the optical waveguide device.

In addition, by selecting a material with a lower refractive index than a refractive index of a material forming the spot size converter as an adhesive for joining the reinforcing member and the optical waveguide substrate, the adhesive layer disposed around the spot size converter functions as a clad layer of the spot size converter.

In a case where the reinforcing member is disposed in a portion where the optical waveguide having the rib structure (hereinafter also referred to as a rib optical waveguide) or the spot size converter is disposed, it is difficult to bond the reinforcing member in parallel to the optical waveguide substrate because the optical waveguide having the rib structure protrudes from the optical waveguide substrate. In addition, the inclination of the reinforcing member may cause damage to the optical waveguide or the like, or the inclination of the clad layer of the spot size converter may cause variations in the MFD.

In Patent Literature No. 1, it is proposed to dispose resin structures such as resists or the like higher than the spot size converter to interpose the spot size converter therebetween, and to reduce the occurrence of damage to the spot size converter and the variation in the MFD. In addition, it is disclosed that a groove is formed on an upper surface of the structure to discharge an excess adhesive.

In a configuration of the related art as in Patent Literature No. 1, the structure occupies a member disposed on an optical waveguide substrate side, which is a member having the largest joint area with the reinforcing member, specifically occupying about 50% or more of an area of a bonding surface of the reinforcing member. FIGS. 1 to 6 are diagrams showing a joint state between the optical waveguide substrate (11) and the reinforcing member 2. FIG. 2 shows a cross section view taken along an alternate long and short dash line A-A′ in FIG. 1, and FIG. 3 shows a cross section view taken along an alternate long and short dash line B-B′ in FIG. 1. Similarly, FIG. 5 shows a cross section view taken along an alternate long and short dash line A-A′ in FIG. 4, and FIG. 6 shows a cross section view taken along an alternate long and short dash line B-B′ of FIG. 4. In FIGS. 1 and 4, a thick dotted line frame 2 indicates a position at which the reinforcing member is disposed.

FIGS. 1 to 3 show a case where a thickness of an adhesive layer AD is thin, and FIGS. 4 to 6 show a case where the thickness of the adhesive layer AD is thick. In general, a linear expansion coefficient of a structure SP differs from a linear expansion coefficient of the adhesive, and during a process in which the adhesive is heated, the structure expands while the adhesive contracts. For example, in a case where a bonding thickness is less than 0.5 μm, a difference in expansion between the structure SP and the reinforcing member 2 reduces an adhesive force, making it easier for them to peel apart. In addition, since a clearance between the structure and the reinforcing member is narrow, it is difficult to discharge air bubbles (BU) entrapped between both, which not only reduces an amount of the adhesive disposed between both but also causes the air bubbles to expand during the heating process, making the peeling between both more likely to occur. In addition, the presence of air bubbles alters characteristics of the clad layer, thereby increasing propagation loss of the optical waveguide.

On the other hand, in a case where the thickness of the adhesive layer exceeds 2.0 μm, as shown in FIG. 6, a fiber or an optical component LB joined to the end portion of the optical waveguide device cannot absorb the contraction of the adhesive, which results in the generation of a crack CR at the joined portion between the adhesive layer and the optical component, making it prone to peeling.

As described above, in the related art, the bonding area and the thickness of the adhesive layer related to the joining between the structure and the reinforcing member have not been considered at all.

### CITATION LIST

### Patent Literature

[Patent Literature No. 1] Japanese Patent Application No. 2020-165004 (filed on Sep. 30, 2020)

### SUMMARY OF INVENTION

### Technical Problem

An object to be achieved by the present invention is to address the aforementioned issues and to provide an optical waveguide device capable of appropriately setting a joint relationship between an optical waveguide substrate and a reinforcing member. In addition, the object is to provide an optical modulation device and an optical transmission apparatus using the optical waveguide device.

### Solution to Problem

In order to achieve the object, the optical waveguide device, and the optical modulation device and the optical transmission apparatus using the same of the present invention have the following technical features.
(1) An optical waveguide device includes: an optical waveguide substrate provided with an optical waveguide; and a reinforcing member disposed on an upper side of the optical waveguide near an end portion of the optical waveguide, the optical waveguide substrate and the reinforcing member being joined through an adhesive layer, in which a plurality of structures are disposed between the optical waveguide substrate and the reinforcing member to interpose the optical waveguide between the plurality of structures, for a first structure, the adhesive layer is disposed between an upper surface of the structure and the reinforcing member, and the first structure has a ratio of an area of the upper surface to an area of a lower surface of the reinforcing member being set to be equal to or more than a predetermined ratio, and a second structure is configured to set a thickness of the adhesive layer disposed between the first structure and the reinforcing member within a predetermined range.
(2) In the optical waveguide device according to (1), the predetermined ratio is 50% or more.
(3) In the optical waveguide device according to (1) or (2), the predetermined range is 0.5 μm or more and 2.0 μm or less.
(4) In the optical waveguide device according to (1), the second structure is laminated on the first structure and disposed on the first structure.
(5) In the optical waveguide device according to (1), at least a part of the first structure is disposed between the optical waveguide and the second structure.
(6) In the optical waveguide device according to (1), an area of an upper surface of the second structure is smaller than the area of the upper surface of the first structure.
(7) In the optical waveguide device according to (1), a spot size converter is formed in the optical waveguide disposed on a lower side of the reinforcing member.
(8) An optical modulation device includes: the optical waveguide device according to (1); a case accommodating the optical waveguide device; and an optical fiber through which a light wave is input into the optical waveguide or output from the optical waveguide.
(9) In the optical modulation device according to (8), the optical waveguide device includes a modulation electrode for modulating the light wave propagating through the optical waveguide, and an electronic circuit that amplifies a modulation signal to be input into the modulation electrode of the optical waveguide device is provided inside the case.
(10) An optical transmission apparatus includes: the optical modulation device according to (8) or (9); and an electronic circuit that outputs a modulation signal causing the optical modulation device to perform a modulation operation.

### Advantageous Effects of Invention

In the present invention, since an optical waveguide device includes: an optical waveguide substrate provided with an optical waveguide; and a reinforcing member disposed on an upper side of the optical waveguide near an end portion of the optical waveguide, the optical waveguide substrate and the reinforcing member being joined through an adhesive layer, in which a plurality of structures are disposed between the optical waveguide substrate and the reinforcing member to interpose the optical waveguide between the plurality of structures, for a first structure, the adhesive layer is disposed between an upper surface of the structure and the reinforcing member, and the first structure has a ratio of an area of the upper surface to an area of a lower surface of the reinforcing member being set to be equal to or more than a predetermined ratio, and a second structure is configured to set a thickness of the adhesive layer disposed between the first structure and the reinforcing member within a predetermined range, it is possible to appropriately set a joint relationship between the optical waveguide substrate and the reinforcing member.

Further, since the predetermined ratio is 50% or more, it is possible to secure sufficient joint strength with the adhesive layer between the first structure and the reinforcing member. In addition, since the predetermined range is 0.5 μm or more and 2.0 μm or less, it is possible to appropriately set the thickness of the adhesive layer between the first structure and the reinforcing member.

By using such an optical waveguide device, it is also possible to provide an optical modulation device and an optical transmission apparatus that have similar effects.

### BRIEF DESCRIPTION OF DRAWINGS

FIG. 1 is a plan view showing an optical waveguide device according to the related art.

FIG. 2 is a cross section view taken along an alternate long and short dash line A-A′ in FIG. 1.

FIG. 3 is a cross section view taken along an alternate long and short dash line B-B′ in FIG. 1.

FIG. 4 is a plan view showing another optical waveguide device according to the related art.

FIG. 5 is a cross section view taken along an alternate long and short dash line A-A′ in FIG. 4.

FIG. 6 is a cross section view taken along an alternate long and short dash line B-B′ in FIG. 4.

FIG. 7 is a plan view showing a first example of an optical waveguide device according to the present invention.

FIG. 8 is a cross section view taken along an alternate long and short dash line A-A′ in FIG. 7.

FIG. 9 is a plan view showing a second example of the optical waveguide device according to the present invention.

FIG. 10 is a cross section view taken along an alternate long and short dash line A-A′ in FIG. 9.

FIG. 11 is a plan view showing a third example of the optical waveguide device according to the present invention.

FIG. 12 is a cross section view taken along an alternate long and short dash line A-A′ in FIG. 11.

FIG. 13 is a plan view showing a fourth example of an optical waveguide device according to the present invention.

FIG. 14 is a cross section view taken along an alternate long and short dash line A-A′ in FIG. 13.

FIG. 15 is a plan view showing a fifth example of the optical waveguide device according to the present invention.

FIG. 16 is a cross section view taken along an alternate long and short dash line A-A′ in FIG. 15.

FIGS. 17A to 17C are plan views showing an application example of a second structure in FIG. 9.

FIGS. 18A to 18C are a plan views showing an application example of the second structure in FIG. 11.

FIG. 19 is a plan view showing an application example of the second structure in FIG. 9.

FIG. 20 is a plan view showing an application example of the second structure in FIG. 15.

FIG. 21 is a plan view showing an application example of the second structure in FIG. 15.

FIG. 22 is a plan view showing an application example of the second structure in FIG. 15.

FIG. 23 is a plan view for describing an optical modulation device and an optical transmission apparatus using the optical waveguide device of the present invention.

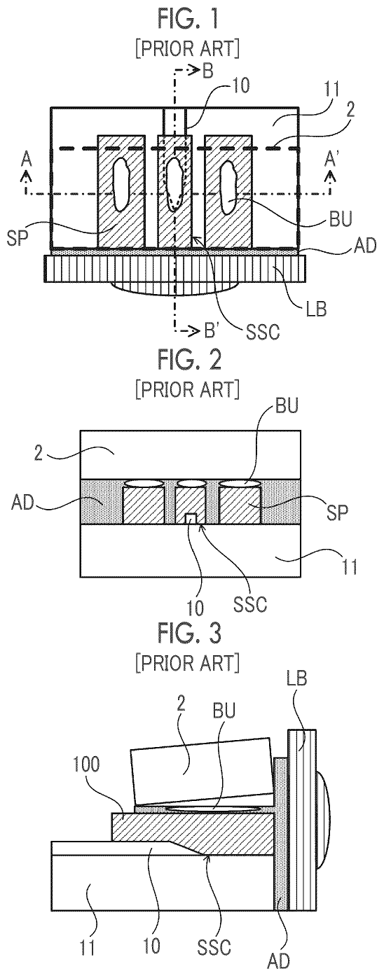

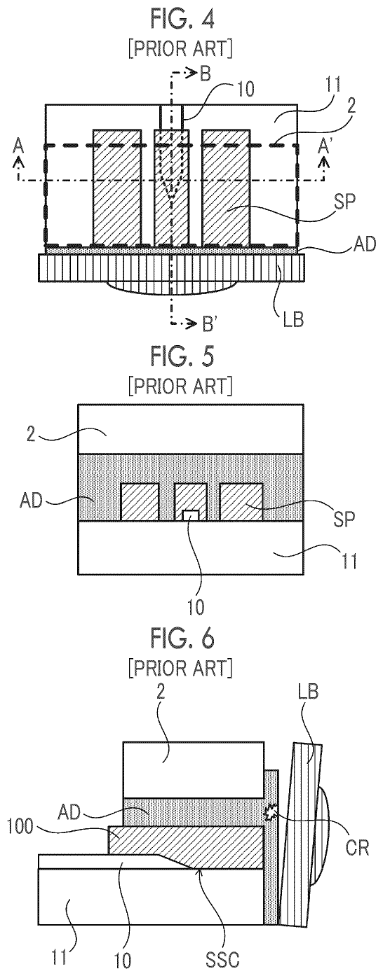

### DESCRIPTION OF EMBODIMENTS

Hereinafter, an optical waveguide device of the present invention will be described in detail using preferred examples.

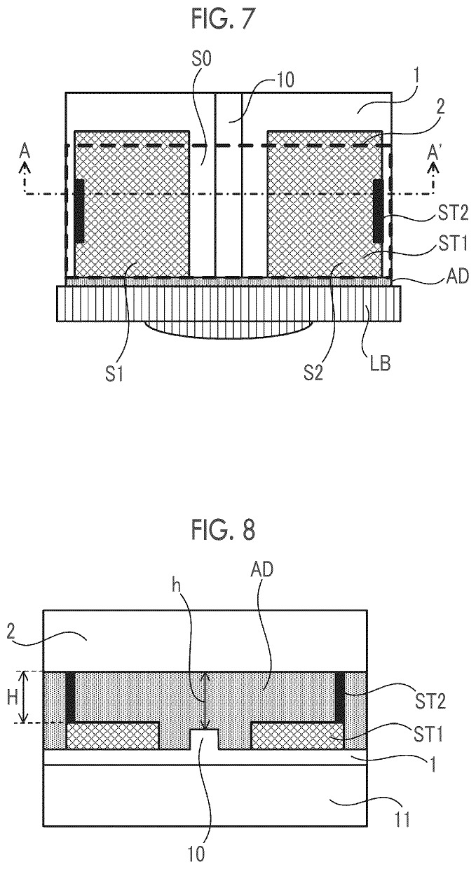

As shown in FIGS. 7 to 22, the optical waveguide device according to the present invention includes: an optical waveguide substrate 1 (11) provided with an optical waveguide 10; and a reinforcing member 2 disposed on an upper side of the optical waveguide near an end portion of the optical waveguide, the optical waveguide substrate and the reinforcing member being joined through an adhesive layer AD, in which a plurality of structures are disposed between the optical waveguide substrate and the reinforcing member to interpose the optical waveguide between the plurality of structures, for a first structure ST1, the adhesive layer is disposed between an upper surface of the structure and the reinforcing member, and the first structure ST1 has a ratio of an area of the upper surface to an area of a lower surface of the reinforcing member being set to be equal to or more than a predetermined ratio, and a second structure ST2 (ST20 to ST22) is configured to set a thickness of the adhesive layer disposed between the first structure and the reinforcing member within a predetermined range.

The vicinity of the end portion of the optical waveguide in the present invention refers to a range of L from the end portion of the optical waveguide in a case where a length of the reinforcing member in an optical waveguide extending direction is L, or a range of L from an end portion of a spot size converter SSC in a case where the spot size converter SSC is formed in the end portion of the optical waveguide, and at least a part of the reinforcing member need only be fixed within these ranges. In addition, considering peeling of an optical block or the like, it is preferable that at least a part of the reinforcing member is fixed within a range of 100 μm or less from the end portion of the optical waveguide or from the end portion of the spot size converter SSC, more preferably within a range of 50 μm or less, and still more preferably within a range of 20 μm or less.

As the optical waveguide substrate 1 used in the optical waveguide device of the present invention, materials having an electro-optic effect such as a substrate formed of lithium niobate (LN), lithium tantalate (LT), lead lanthanum zirconate titanate (PLZT), or the like, or a vapor-phase growth film formed of these materials can be used.

In addition, various materials such as semiconductor materials, organic materials, or the like can also be used as the optical waveguide.

As the optical waveguide 10, an optical waveguide formed by thermally diffusing Ti or the like on an LN substrate or a rib optical waveguide formed by causing a part of a substrate corresponding to the optical waveguide to have a protruding shape by, for example, etching a part of the substrate 1 other than the optical waveguide or by forming grooves on both sides of the optical waveguide can be used. Furthermore, a refractive index can be further increased by diffusing Ti or the like on a surface of the substrate using a thermal diffusion method, a proton exchange method, or the like in accordance with the rib optical waveguide. While the following description will be mainly made with reference to the rib optical waveguide 10 and a spot size converter SSC, the same idea also applies to other optical waveguides having a protruding part, such as a Ti diffused waveguide or the like.

In addition, the “optical waveguide” in the present invention is a concept including the “spot size converter”.

A thickness of the substrate (thin plate) on which the optical waveguide 10 is formed is set to be 10 μm or lower, more preferably 5 μm or lower, and still more preferably 1 μm or lower in order to achieve velocity matching between a microwave of a modulation signal and a light wave. In addition, a height of the rib optical waveguide is set to be 4 μm or lower, more preferably 3 μm or lower, and still more preferably 1 μm or lower or 0.4 μm or lower. In addition, it is also possible to form a vapor-phase growth film on the holding substrate 11 and to process the film to have a shape of the optical waveguide.

The substrate 1 on which the optical waveguide is formed is adhesively fixed to the holding substrate 11 via direct joining or through an adhesive layer of resin or the like in order to increase mechanical strength. As the holding substrate 11 to be directly joined, a substrate including an oxide layer of a material such as crystal, glass, sapphire, or the like that has a lower refractive index than those of the optical waveguide and the substrate on which the optical waveguide is formed, and that has a similar coefficient of thermal expansion to the optical waveguide or the like is preferably used. Composite substrates obtained by forming a silicon oxide layer on a silicon substrate or other composite substrates obtained by forming a silicon oxide layer on an LN substrate, which are abbreviated to SOI and LNOI, can also be used.

The “optical waveguide substrate” in the present invention is a concept including not only the “optical waveguide” and the “substrate on which the optical waveguide is formed” but also the “holding substrate”.

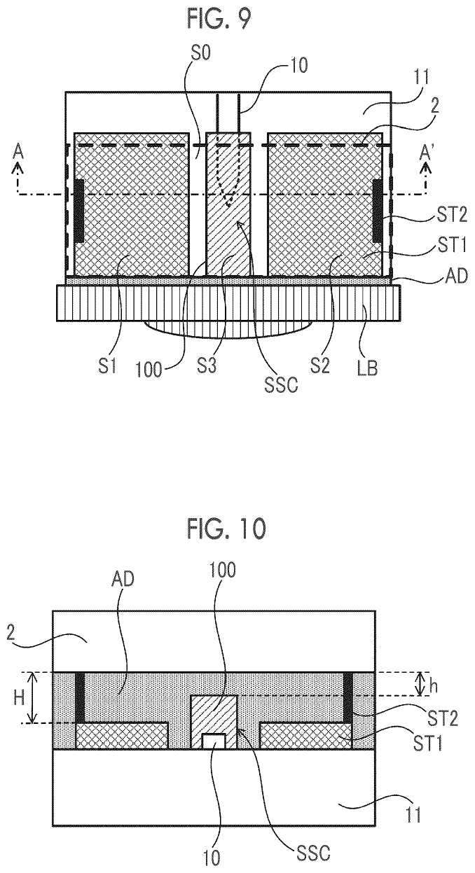

For example, in a case where, for example, a mode field diameter of the optical waveguide 10 is 3 μm or less, which differs from a mode field diameter of an optical fiber or the like (approximately 10 μm), the spot size converter SSC is formed as shown in FIGS. 9 and 10. The spot size converter applied to the optical waveguide device of the present invention is not limited to these and may be a so-called taper-shaped spot size converter in which the width or height of the optical waveguide gradually increases toward an end portion of the substrate. In FIGS. 9 and 10, a configuration is shown in which the spot size converter SSC has the rib optical waveguide 10 with a tapered shape where a width of a distal end is reduced, and a block portion 100 serving as a core portion is disposed to surround the distal end.

In addition, as shown in FIG. 10, a distance h between an upper surface of the spot size converter SSC and the reinforcing member (upper substrate) 2 is set to 0.2 times to 1.5 times the mode field diameter of the spot size converter SSC.

In the optical waveguide device of the present invention, the reinforcing member 2 is disposed on the upper side of the optical waveguide (rib optical waveguide 10) or the spot size converter SSC. A material having approximately the same refractive index and the same linear expansion coefficient as the holding substrate 11 is used in the reinforcing member 2. In a case where linear expansion coefficients match, a problem such as detachment of the reinforcing member (upper substrate) due to thermal stress or the like can be reduced, and an optical waveguide device having excellent thermostability is obtained. An adhesive formed of UV curable resin, resin such as acrylbased resin or epoxy-based resin, or the like can be used in the adhesive (adhesive layer) 3 with which the reinforcing member 2 is joined to the optical waveguide substrate 1 or to the holding substrate 11.

A feature of the optical waveguide device of the present invention is that at least the first structure ST1 that maintains joint strength between the optical waveguide substrate 1 (11) and the reinforcing member 2 and the second structure ST2 (ST20 to ST22) for appropriately setting the thickness of the adhesive layer between the optical waveguide substrate and the reinforcing member are included.

In the present example, the second structure ST2 is formed on an upper portion of the first structure ST1, and an upper surface of the second structure ST2 is positioned at a higher position than an upper surface of the first structure ST1.

The first structures ST1 are disposed to interpose the optical waveguide therebetween and function as structures for protecting the optical waveguide, including the spot size converter SSC, similar to Patent Literature No. 1. The first structure ST1 needs to secure stable joint strength through the adhesive layer disposed between the first structure and the reinforcing member 2. Therefore, as shown in FIGS. 7 and 9, it is preferable that a ratio of a sum of areas of the upper surfaces of the first structures ST1 (S1+S2) to an area S0 of the lower surface of the reinforcing member 2 is 50% or more. It is preferable that the areas of the upper surfaces of the first structures excludes areas of a portion in which the second structures ST2 are disposed on the upper surfaces of the first structures ST1, as shown in FIGS. 7 to 10. In addition, when a height of the block portion 100 of the spot size converter SSC is approximately the same as a height of the first structure, it is possible to include an area of the block portion 100 in the sum of the areas of the upper surfaces of the first structures.

As shown in FIG. 8, by making the height of the first structure ST1 higher than the height of the optical waveguide 10, it is possible to impart a function of protecting the optical waveguide (this also applies to the spot size converter) to the first structure, but it is also required to note that air bubbles or the like may easily enter between the optical waveguide and the first structure, or between the first structures.

It is preferable that the second structures ST2 are also disposed to interpose the optical waveguide therebetween, and that a clearance between the second structures interposing the optical waveguides therebetween is as wide as possible in order to uniformly maintain a clearance between the optical waveguide substrate 1 (11) and the reinforcing member 2. The second structure ST2 plays a role solely of maintaining a clearance H between the first structure ST1 and the reinforcing member 2 within a predetermined range. Specifically, the predetermined range is 0.5 μm or more and 2.0 μm or less. In addition, in order to reduce loss of propagating light of the reinforcing member, it is preferable that the clearance h between the optical waveguide 10 (spot size converter SSC) and the reinforcing member 2 is set in a range of 0.2 times to 1.5 times the MFD of the optical waveguide or the like.

Regarding the second structure ST2, an upper end of the second structure is in contact with the reinforcing member 2, or a thickness of an adhesive is less than 0.5 μm even when there is the adhesive between the upper end and the reinforcing member 2. Therefore, it is preferable to set an area of the upper surface of the second structure as small as possible. The number of the second structures ST2 is not limited to two as shown in FIGS. 7 to 10, and may be two or more as will be described below. In a case where a width of the second structure is large or the number of second structures is large, mechanical strength of the second structure is also increased, which can further enhance the reliability as a member that protects the optical waveguide (spot size converter SSC) as shown in FIG. 10, or as a member that maintains the clearance H between the first structure ST1 and the reinforcing member 2 within the predetermined range.

FIGS. 7 to 10 show a disposition in which the second structure ST2 is laminated on an upper side of the first structure ST1, but the present invention is not limited thereto, and as shown in FIGS. 11 to 16, the second structure may be disposed separately from the first structure.

In a case where the second structure is disposed separately from the first structure, it is preferable that the second structure is disposed at an outer side of the first structure, and the clearance between the second structures is as wide as possible. The first structure may be disposed not only on both sides of the optical waveguide but also on only one side of the optical waveguides. In addition, the first structure may be disposed not only between the optical waveguide and the second structure but also on an outer side of the second structure (a side opposite to the optical waveguide).

As a material for forming the first and second structures, resin materials such as photoresist (permanent resist) are suitable for various shapes and disposition and can be preferably used. In addition, it is also possible to use a combination of materials used in a manufacturing process of the optical waveguide device, such as a conductive material, such as gold or the like, used for a part of the optical waveguide substrate 1 or an electrode, a resin material forming the block portion of the spot size converter SSC or a protective film for the optical waveguide other than the block portion, and the like. As resin used in the permanent resist, various materials such as polyamide-based resin, melamine-based resin, phenol-based resin, amino-based resin, epoxy-based resin, and the like can be used.

As a combination of materials forming the first and second structures, in FIGS. 7 to 10, for example, a configuration can be adopted in which the same conductive material as the electrode is used for the first structure ST1 and a resin material is used for the second structure ST2, or a configuration can be adopted in which a resin material such as a photoresist (permanent resist) or the same conductive material as the electrode is used for both the first structure ST1 and the second structure ST2.

In addition, the same material as the optical waveguide substrate 1 may be used as a material other than the above-described materials, and various processes such as sputtering, vapor deposition, and the like can be used using quartz, other glass materials, or the like.

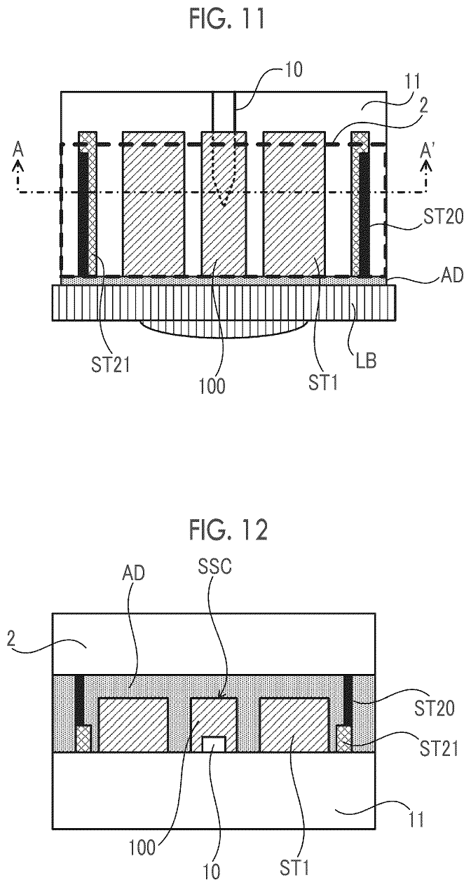

In FIGS. 11 and 12, the first structure ST1 and the second structure are formed separately from each other, and the first structure can be formed of the same material as the protective film (permanent resist) that covers the optical waveguide or the same material as the block portion 100 of the spot size converter SSC. In addition, the second structure has a laminated structure including a part ST21 formed of the same material as the electrode material and a part ST20 formed of the photoresist material.

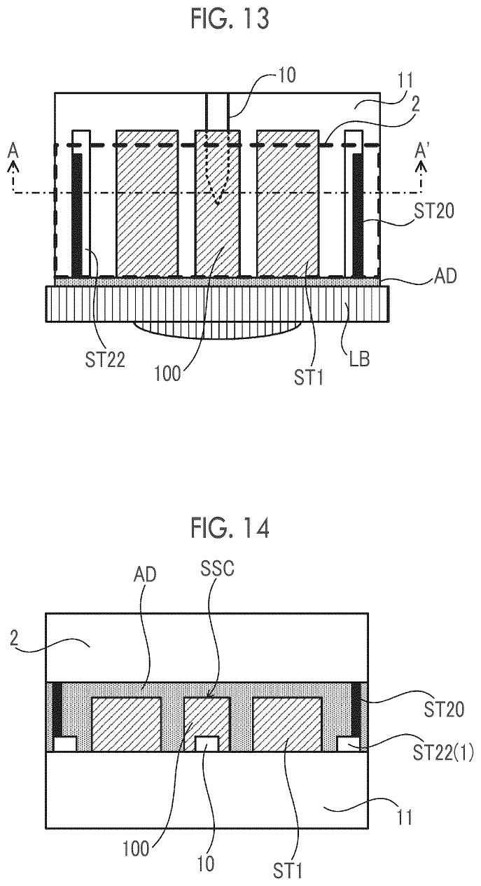

In FIGS. 13 and 14, the second structure has a structure in which the part ST20 formed of the photoresist material is laminated on the part ST22 of the optical waveguide substrate 1.

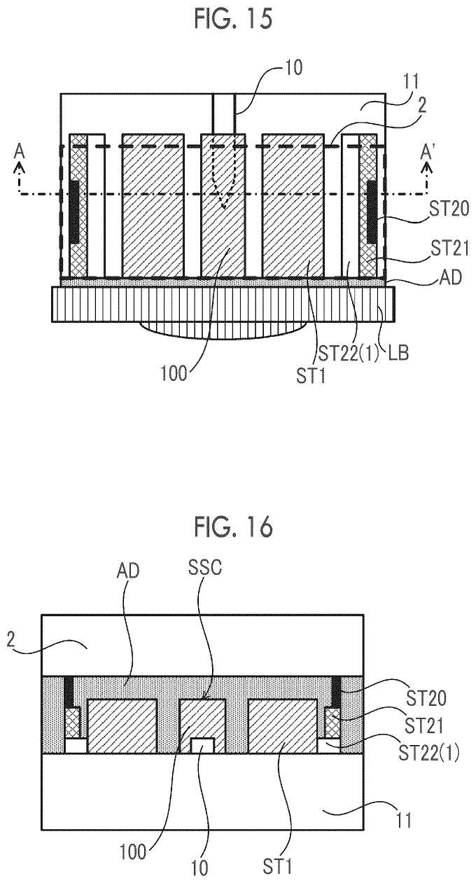

Further, in FIGS. 15 and 16, in the second structure, the part ST21 formed of the electrode material is laminated on the part ST22 of the optical waveguide substrate 1, and the part ST20 formed of the photoresist material is further laminated.

In the examples shown in FIGS. 11 to 16, the second structures ST2 and ST20 are formed separately from the first structure ST1 on one side of the structure ST1, not on the upper portion of the first structure ST1, and upper surfaces of the second structures ST2 and ST20 are formed at positions higher than the upper surface of the first structure ST1.

In a case where a height of each of the part ST21 formed of the same material as the electrode material in FIGS. 11 and 12 and the part ST22 of the optical waveguide substrate 1 in FIGS. 13 and 14 is the same as the height of the optical waveguide 10 of the spot size converter SSC, the block portion 100 of the spot size converter SSC, the first structure ST1, and the part ST20 formed of the photoresist material, which is the second structure, may be formed of the same material, and may be formed to have the same height in the same process. As a result, the manufacturing process can be significantly streamlined, and the variation in the height of each structure can be reduced.

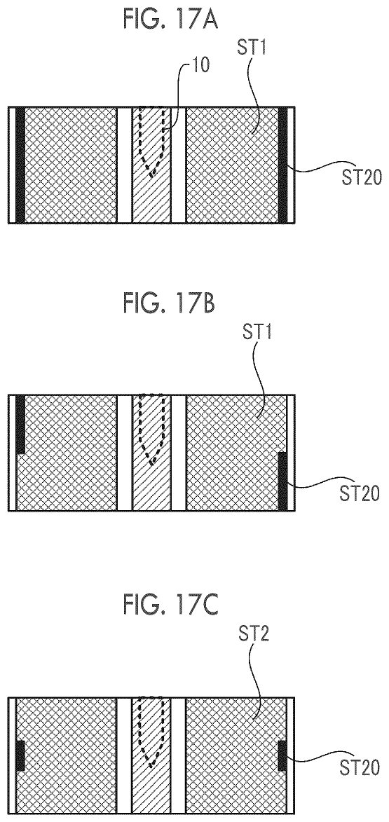

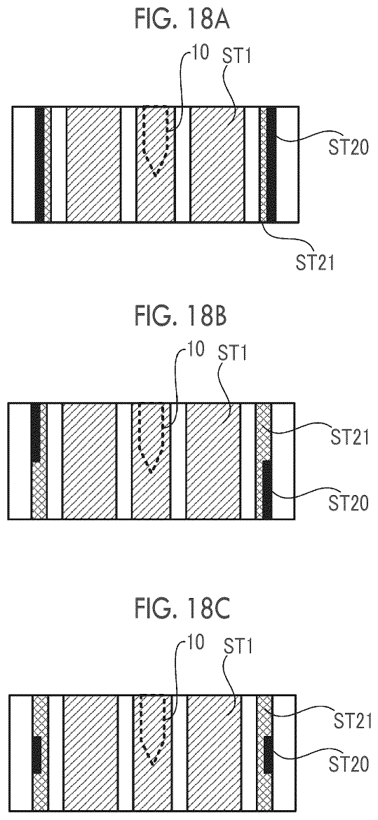

FIGS. 17A to 17C are diagrams for describing a variation of the disposition of the second structure ST2 disposed on the first structure ST1. FIGS. 18A to 18C are diagrams for describing a variation of the disposition of the second structures (ST20 and ST21) that are disposed separately from the first structure ST1. In any of the diagrams, only the portion positioned below the reinforcing member is extracted and shown. As shown in FIG. 17A and FIG. 18A, it is possible to form the second structure that extends longitudinally along an extending direction of the optical waveguide. As the length increases, the mechanical strength of the second structure is enhanced. However, since air bubbles can escape only in a vertical direction of the drawing from the adhesive layer in a region interposed between the two second structures, there is a higher likelihood that air bubbles remain.

As shown in FIG. 17B and FIG. 18B, by disposing the second structures alternately in the extending direction of the optical waveguide, stability of the disposition of the reinforcing member (prevention of rattling) is also increased while securing a route for discharging the air bubbles. As shown in FIG. 17C and FIG. 18C, by shortening the length of the second structure, the air bubbles can be discharged, and the number of adhesive layers disposed between the second structure and the reinforcing member also can be reduced, thereby lowering the likelihood that air bubbles remain.

Such a configuration may appear to be a very unstable configuration because the reinforcing member is supported only by the two second structures, but this can be resolved by improving a manufacturing process. For example, when a plurality of optical waveguide substrates are disposed on a wafer, the optical waveguide substrates are disposed such that the spot size converters (SSC) in a pair of optical waveguide substrates face each other, and the reinforcing member is fixed on the total of four second structures formed in the two spot size converters (SSC). As a result, the reinforcing member is stably fixed to the second structures. When cutting the optical waveguide substrate, a pair of optical waveguide substrates can be obtained by cutting through a center of the two spot size converters (SSC).

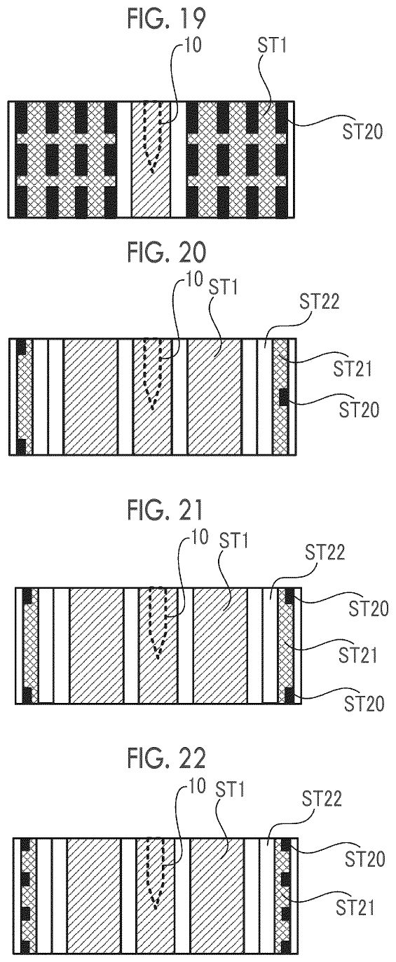

As another variation of the second structure, as shown in FIG. 19, a large number of second structures (a plurality in both the extending direction and the direction orthogonal to the extending direction of the optical waveguide) may be disposed to enhance a holding function of the second structure for the reinforcing member. However, to avoid the presence of air bubbles between the second structures, it is preferable to secure a sufficient clearance beyond what is shown in the drawing.

FIG. 20 shows an example in which the number of second structures is set to 3, FIG. 21 shows an example in which the number of second structures is set to 4, and FIG. 22 shows an example in which the number of second structures is set to 8. In general, by securing three points on a plane in which the reinforcing member is supported, the disposition of the reinforcing member is stabilized. Therefore, in a case where the area of the upper surface of the second structure is small, it is preferable to dispose three or more second structures.

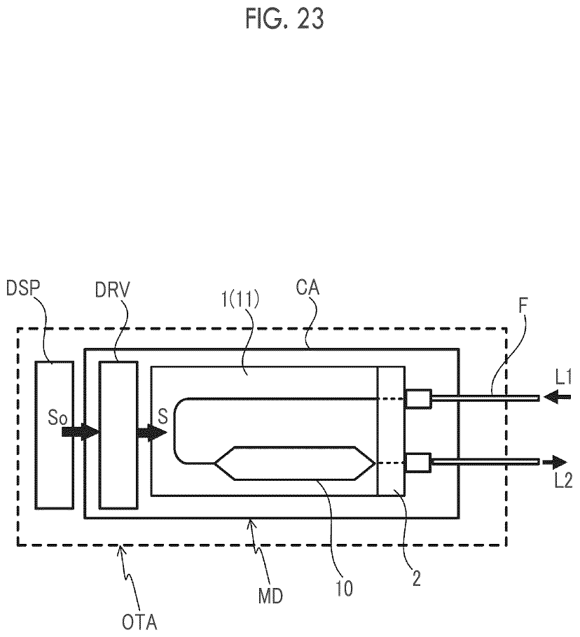

The optical waveguide device of the present invention is provided with a modulation electrode that modulates the light wave propagating through the optical waveguide 10 in the optical waveguide substrate 1 (11) and is accommodated inside a case CA as shown in FIG. 23. Furthermore, an optical modulation device MD can be configured by providing an optical fiber (F) through which the light wave is input into the optical waveguide or output from the optical waveguide. In FIG. 23, the optical fiber is introduced into the case through a through-hole that penetrates a side wall of the case, and is directly joined to the optical waveguide device. The optical waveguide device and the optical fiber can also be optically connected through a space optical system.

An optical transmission apparatus OTA can be configured by connecting, to the optical modulation device MD, an electronic circuit (digital signal processor DSP) that outputs a modulation signal S₀ causing the optical modulation device MD to perform a modulation operation. A modulation signal S to be applied to the optical waveguide device is required to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce the propagation loss of the modulation signal from the driver circuit.

### INDUSTRIAL APPLICABILITY

As described above, according to the present invention, it is possible to provide an optical waveguide device capable of appropriately setting a joint relationship between an optical waveguide substrate and a reinforcing member. In addition, it is possible to provide an optical modulation device and an optical transmission apparatus using the optical waveguide device.

### REFERENCE SIGNS LIST

1: substrate (thin plate, film body) on which optical waveguide is formed
2: reinforcing member
AD: adhesive (adhesive layer)
10: rib optical waveguide
11: holding substrate (part of optical waveguide substrate)
SSC: spot size converter
ST1: first structure
ST2, ST20 to ST22: second structure
LB: optical block

1. An optical waveguide device comprising:
an optical waveguide substrate provided with an optical waveguide; and
a reinforcing member disposed on an upper side of the optical waveguide near an end portion of the optical waveguide, the optical waveguide substrate and the reinforcing member being joined through an adhesive layer,
wherein a plurality of structures are disposed between the optical waveguide substrate and the reinforcing member to interpose the optical waveguide between the plurality of structures,
for a first structure, the adhesive layer is disposed between an upper surface of the structure and the reinforcing member, and the first structure has a ratio of an area of the upper surface to an area of a lower surface of the reinforcing member being set to be equal to or more than a predetermined ratio, and
a second structure is configured to set a thickness of the adhesive layer disposed between the first structure and the reinforcing member within a predetermined range.

2. The optical waveguide device according to claim 1,
wherein the predetermined ratio is 50% or more.

3. The optical waveguide device according to claim 1,
wherein the predetermined range is 0.5 μm or more and 2.0 μm or less.

4. The optical waveguide device according to claim 1,
wherein the second structure is laminated on the first structure and disposed on the first structure.

5. The optical waveguide device according to claim 1,
wherein at least a part of the first structure is disposed between the optical waveguide and the second structure.

6. The optical waveguide device according to claim 1,
wherein an area of an upper surface of the second structure is smaller than the area of the upper surface of the first structure.

7. The optical waveguide device according to claim 1,
wherein a spot size converter is formed in the optical waveguide disposed on a lower side of the reinforcing member.

8. An optical modulation device comprising:
the optical waveguide device according to claim 1;
a case accommodating the optical waveguide device; and
an optical fiber through which a light wave is input into the optical waveguide or output from the optical waveguide.

9. The optical modulation device according to claim 8,
wherein the optical waveguide device includes a modulation electrode for modulating the light wave propagating through the optical waveguide, and
an electronic circuit that amplifies a modulation signal to be input into the modulation electrode of the optical waveguide device is provided inside the case.

10. An optical transmission apparatus comprising:
the optical modulation device according to claim 8; and
an electronic circuit that outputs a modulation signal causing the optical modulation device to perform a modulation operation.

11. The optical waveguide device according to claim 2,
wherein the predetermined range is 0.5 μm or more and 2.0 μm or less.

12. An optical transmission apparatus comprising:
the optical modulation device according to claim 9; and
an electronic circuit that outputs a modulation signal causing the optical modulation device to perform a modulation operation.
